(19) United States
(12) Patent Application Publication
(10) Pub. No.: US 2025/0123780 A1
(43) Pub. Date: Apr. 17, 2025

(54) INFORMATION PROCESSING SYSTEM, NON-TRANSITORY COMPUTER READABLE MEDIUM AND INFORMATION PROCESSING METHOD

(71) Applicant: FUJIFILM Business Innovation Corp., Tokyo (JP)

(72) Inventor: Takuma MUNEHIRO, Kanagawa (JP)

(73) Assignee: FUJIFILM Business Innovation Corp., Tokyo (JP)

(21) Appl. No.: 18/635,616

(22) Filed: Apr. 15, 2024

(30) Foreign Application Priority Data
Oct. 11, 2023 (JP) 2023-176250

(51) Int. Cl. G06F 3/12

(52) U.S. Cl. CPC G06F 3/1212; G06F 3/1238; G06F 3/1268

(57) ABSTRACT

An information processing system includes at least one processor configured to, when an image forming apparatus accepts a new job after accepting a job, sets execution timing of the new job to be before completion of a previous job, which is accepted previously, in a case where a sum of a first waiting time from a predicted arrival time of a previous user who has given an instruction for the previous job at the image forming apparatus to the completion of the previous job and a second waiting time from a predicted arrival time of a new user who has given an instruction for the new job at the image forming apparatus to completion of the new job is shorter than the sum in a case where the new job is started after the completion of the previous job.

### CROSS-REFERENCE TO RELATED APPLICATIONS

This application is based on and claims priority under 35 USC 119 from Japanese Patent Application No. 2023-176250 filed Oct. 11, 2023.

### BACKGROUND

### (i) Technical Field

The present disclosure relates to an information processing system, a non-transitory computer readable medium and an information processing method.

### (ii) Related Art

Japanese Unexamined Patent Application Publication No. 2014-200915 describes an image forming apparatus that schedules the execution of a print job requested by a user such that the execution of the print job is completed before the user arrives at an apparatus main body.

### SUMMARY

Aspects of non-limiting embodiments of the present disclosure relate to making the sum of waiting times shorter, as compared with a case where a new job is started only after completion of a previous job.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including at least one processor configured to, when an image forming apparatus accepts a new job after accepting a job, sets execution timing of the new job to be before completion of a previous job, which is accepted previously, in a case where a sum of a first waiting time from a predicted arrival time of a previous user who has given an instruction for the previous job at the image forming apparatus to the completion of the previous job and a second waiting time from a predicted arrival time of a new user who has given an instruction for the new job at the image forming apparatus to completion of the new job is shorter than the sum in a case where the new job is started after the completion of the previous job.

### BRIEF DESCRIPTION OF THE DRAWINGS

An exemplary embodiment of the present disclosure will be described in detail based on the following figures, wherein:

FIG. 1 is a block diagram illustrating an example of an electronic configuration of an information processing system according to an exemplary embodiment;

FIG. 2 is a block diagram illustrating an example of a functional configuration of the information processing system according to the exemplary embodiment;

FIG. 3A is a conceptual diagram schematically illustrating the time required to complete each of walk-up jobs as a previous job and a new job in the information processing system according to the exemplary embodiment;

FIG. 3B is a conceptual diagram schematically illustrating a waiting time of the previous user and a waiting time of the new user when the new job is executed after the completion of the previous job in the information processing system according to the exemplary embodiment;

FIG. 3C is a conceptual diagram schematically illustrating a waiting time of the previous user and a waiting time of the new user when the new job is executed before the completion of the previous job in the information processing system according to the exemplary embodiment;

FIG. 4A is another conceptual diagram schematically illustrating the time required to complete each of walk-up jobs as the previous job and the new job in the information processing system according to the exemplary embodiment;

FIG. 4B is a conceptual diagram schematically illustrating a waiting time of the previous user and a waiting time of the new user when the new job is executed before the completion of the previous job in the information processing system according to the exemplary embodiment;

FIG. 4C is a conceptual diagram schematically illustrating a waiting time of the previous user and a waiting time of the new user when the new job is executed after the completion of the previous job in the information processing system according to the exemplary embodiment;

FIG. 5A is a conceptual diagram schematically illustrating the time required to complete each of remote jobs as the previous job and the new job in the information processing system according to the exemplary embodiment;

FIG. 5B is a conceptual diagram schematically illustrating a waiting time of the previous user and a waiting time of the new user when the new job is executed before the completion of the previous job in the information processing system according to the exemplary embodiment;

FIG. 5C is a conceptual diagram schematically illustrating a waiting time of the previous user and a waiting time of the new user when the new job is executed after the completion of the previous job in the information processing system according to the exemplary embodiment;

FIG. 6A is another conceptual diagram schematically illustrating the time required to complete each of remote jobs as the previous job and the new job in the information processing system according to the exemplary embodiment;

FIG. 6B is a conceptual diagram schematically illustrating a waiting time of the previous user and a waiting time of the new user when the new job is executed before the completion of the previous job in the information processing system according to the exemplary embodiment;

FIG. 6C is a conceptual diagram schematically illustrating a waiting time of the previous user and a waiting time of the new user when the new job is executed after the completion of the previous job in the information processing system according to the exemplary embodiment;

FIG. 7A is another conceptual diagram schematically illustrating the time required to complete each of remote jobs as the previous job and the new job in the information processing system according to the exemplary embodiment;

FIG. 7B is a conceptual diagram schematically illustrating a waiting time of the previous user and a waiting time of the new user when the new job is executed before the completion of the previous job in the information processing system according to the exemplary embodiment;

FIG. 8 is a conceptual diagram illustrating a positional relationship among an input device, an image forming apparatus, and a mobile terminal of a user in the information processing system according to the exemplary embodiment;

FIG. 9A is a conceptual diagram schematically illustrating a state where the previous user is not detected in an area within a specified distance from the image forming apparatus when the execution of the new job after the completion of the previous job is set in the information processing system according to the exemplary embodiment;

FIG. 9B is a conceptual diagram schematically illustrating a state where the setting for execution of the new job after the completion of the previous job has been changed in the information processing system according to the exemplary embodiment; and

FIG. 10 is a flowchart illustrating an example of a posture abnormality detection process according to the exemplary embodiment.

### DETAILED DESCRIPTION

An information processing system and an information processing program according to an exemplary embodiment of the present disclosure will be described below with reference to the drawings. Constituent elements denoted by the same reference signs in the respective drawings mean the same constituent elements. Note that, unless otherwise particularly specified in the specification, each constituent element is not limited to one, and may be a plurality of constituent elements.

Furthermore, the description of the same components and reference numerals in the drawings may be omitted. The present disclosure is not limited to the exemplary embodiment below and may be implemented with appropriate modifications, such as omission of a component, replacement with a different component, and use of the one exemplary embodiment and various modifications in combination, within the scope of the object of the present disclosure.

### <Information Processing System>

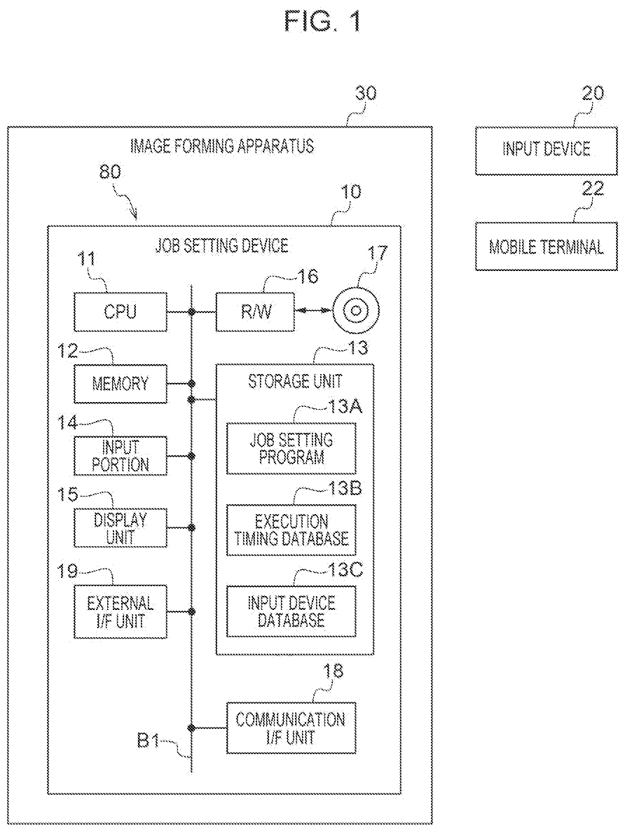

An information processing system 80 illustrated in FIG. 1 is a system built in a job setting device 10 in an image forming apparatus 30 and is used in combination with an input device 20 and a mobile terminal 22.

The “system” according to the present disclosure includes any of a system configurated by a single device, a system configurated by a plurality of devices, and a system constructed in a higher-level device or system.

For example, the information processing system 80 according to the present exemplary embodiment may be constructed in the job setting device 10 in the image forming apparatus 30, but may be constructed in the job setting device 10 provided separately from the image forming apparatus 30, or may be constructed across the input device 20 and the mobile terminal 22.

Furthermore, various processes performed by the information processing system 80 may be performed by a cloud, an on-premise server, an edge server, an endpoint, or the like.

The information processing system 80 is used to improve efficiency of execution of various jobs by the image forming apparatus 30 shared by a plurality of users. Specifically, the information processing system 80 is used to, when the image forming apparatus 30 accepts a plurality of jobs at the same time, reduce the waiting time for a plurality of users who have given instructions for these jobs.

### (Input Device)

The input device 20 is, as an example, a personal computer or a tablet terminal operated by a user. The input device 20 may give instructions to the image forming apparatus 30 to execute various jobs. Jobs for which instructions are given to be executed by the input device 20 are roughly classified into walk-up jobs and remote jobs.

The walk-up job is a job that “requires” a direct operation of the image forming apparatus 30 for execution, and this job includes copying, scanning, FAX transmission accompanied by scanning, printing that requires user authentication, and the like.

The “direct operation of the image forming apparatus 30” is, as an example, an operation of setting a document on a document table of the image forming apparatus 30, such as copying of a printed material and FAX. Furthermore, the “printing that requires user authentication” is, for printing execution, a print job that requires an authentication operation (direct operation) by input of a signal to the image forming apparatus 30 using an authentication card, or the like, which stores personal information. The present disclosure is applicable regardless of whether user authentication is required for printing.

When the printed matter is copied, instruction information such as the number of copies, color or monochrome output, and a scale may be input via an input unit such as a touch panel in the image forming apparatus 30. According to the present disclosure, however, they may be input via the input device 20. Furthermore, a transmission destination for FAX transmission may also be input via the input device 20. A user inputs various types of instruction information for a walk-up job via the input device 20.

Furthermore, the remote job is a job that “does not require” a direct operation of the image forming apparatus 30 for execution, and this job includes printing that does not require user authentication, FAX reception accompanied by printing, and the like. Remote jobs may be executed while the user is moving.

### (Mobile Terminal)

The mobile terminal 22 is a terminal such as a smartphone or a smart watch carried by a user and has a communication function capable of identifying the position in a space where the image forming apparatus 30 and the input device 20 are installed. The communication function is not particularly limited, and examples thereof include a communication function by Bluetooth (registered trademark). The instruction to execute various jobs to the image forming apparatus 30 may be executed via the mobile terminal 22.

### (Image Forming Apparatus)

The image forming apparatus 30 accepts a job by an input operation via the input device 20 and a direct operation and executes the specified job. The jobs executed by the image forming apparatus 30 include the walk-up job and the remote job described above.

### (Electrical Configuration of Job Setting Device)

As illustrated in FIG. 1, the job setting device 10 includes a CPU (central processing unit: processor) 11, a memory 12 as a temporary storage area, a nonvolatile storage unit 13, an input unit 14, a display unit 15 such as a liquid crystal display, a medium read/write device (R/W) 16, a communication interface (I/F) unit 18, and an external I/F unit 19. The CPU 11, the memory 12, the storage unit 13, the input unit 14, the display unit 15, the medium read/write device 16, the communication I/F unit 18, and the external I/F unit 19 are connected to each other via a bus B1. The medium read/write device 16 reads information written in a recording medium 17 and writes information in the recording medium 17. The communication I/F unit 18 is an interface to communicably connect, for example, a server provided outside the job setting device 10 or various terminals (a personal computer including the input device 20 and the mobile terminal 22, a smartphone, a tablet, and the like) used by a user to the job setting device 10. For the communication I/F unit 18, for example, a communication standard such as Wi-Fi (registered trademark), Bluetooth (registered trademark), or a local area network (LAN) is used.

### (Storage Unit)

The storage unit 13 is implemented by a hard disk drive (HDD), a solid state drive (SSD), a flash memory, or the like. The storage unit 13 as a storage medium stores a job setting program 13A. The job setting program 13A is stored in the storage unit 13 when the recording medium 17 in which the job setting program 13A is written is set in the medium read/write device 16 and the medium read/write device 16 reads the job setting program 13A from the recording medium 17. The CPU 11 reads the job setting program 13A from the storage unit 13, loads the job setting program 13A to the memory 12, and sequentially executes processes included in the job setting program 13A. The storage unit 13 stores an execution timing database 13B and an input device database 13C, which will be described below.

### (Input Unit)

In the input unit 14, the user executes an operation to start and end the job setting program 13A. The user is, as an example, an administrator of the information processing system 80. A touch panel of the image forming apparatus 30 may also serve as the input unit 14.

### (Display Unit)

The display unit 15 displays information for starting and ending the job setting program 13A. A touch panel of the image forming apparatus 30 may also serve as the display unit 15.

### (Functional Configuration of Job Setting Device)

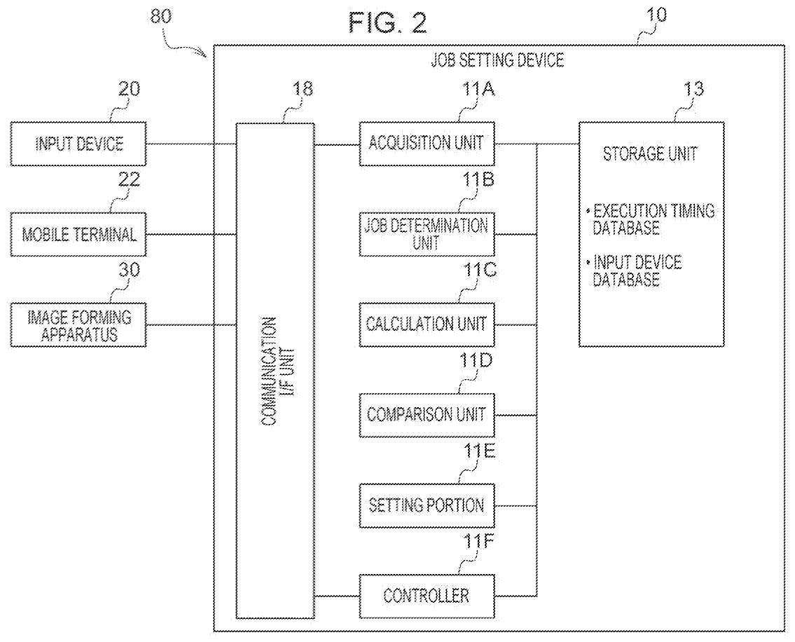

Next, a functional configuration of the job setting device 10 according to the present exemplary embodiment will be described with reference to FIG. 2. As illustrated in FIG. 2, the job setting device 10 includes an acquisition unit 11A, a job determination unit 11B, a calculation unit 11C, a comparison unit 11D, a setting portion 11E, and a controller 11F. The CPU 11 of the job setting device 10 executes the job setting program 13A to function as the acquisition unit 11A, the job determination unit 11B, the calculation unit 11C, the comparison unit 11D, the setting portion 11E, and the controller 11F.

In FIG. 2, the image forming apparatus 30 is illustrated separately from the job setting device 10 in order to indicate that the image forming apparatus 30 is a target to be controlled by the controller 11F.

### (Acquisition Unit)

The acquisition unit 11A acquires a job accepted by the image forming apparatus 30 and various types of instruction information (for example, instruction information such as the number of prints and color printing) in the job. The acquisition unit 11A acquires the position of each user from the mobile terminals 22 carried by a plurality of users.

### (Job Determination Unit)

The job determination unit 11B determines the type of job acquired by the acquisition unit 11A. That is, it is determined whether the acquired job is a walk-up job or a remote job.

When the acquisition unit 11A acquires a new job, the job determination unit 11B determines the presence or absence of a previous job accepted in advance.

### (Calculation Unit)

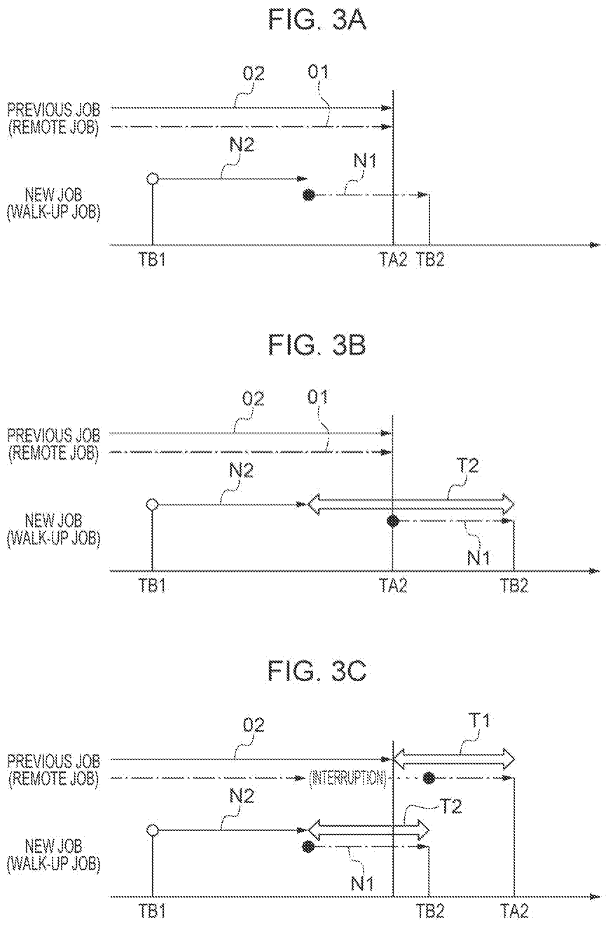

FIG. 3A illustrates, in a case where the acquired previous job is present and the acquisition unit 11A acquires a new job, a timeline of a net time N1 required to execute the new job, a moving time N2 of a new user who has given an instruction for the new job, an execution time 01 of the previous job, and a moving time 02 of a previous user who has given an instruction for the previous job.

Further, the acceptance time of the new job is indicated as TB1, the end time is indicated as TB2, and the time at which the previous job ends is indicated as TA2. The function of the calculation unit 11C will be described below with reference to the drawings.

In the following description, it is assumed that the new user starts moving toward the image forming apparatus 30 immediately after giving an instruction for the new job.

1. Time Calculation when New Job is Acquired

When the acquisition unit 11A acquires the new job, the calculation unit 11C calculates the time required from the acceptance time of the new job until the completion of the new job (e.g., the time from TB1 to TB2 illustrated in FIG. 3A).

At this time, when the acquisition unit 11A acquires the new job, the calculation unit 11C calculates the moving time N2 required from the acceptance time of the new job to the movement of the new user (the user who has given an instruction for the new job) to the image forming apparatus 30. A method for calculating the moving time N2 will be described below.

When the new job is a walk-up job, the calculation unit 11C calculates the total time of the moving time N2 and the net time N1 required to execute the new job as the time required until the completion of the new job (the time from TB1 to TB2). The net time N1 required to execute the new job is calculated based on parameters (such as the data size, the number of copies, and whether to perform single-sided printing or double-sided printing) of the job and machine specifications (such as the communication speed) of the image forming apparatus 30.

Conversely, when the new job is a remote job, the controller 11F described below controls the image forming apparatus 30 to execute the new job while the new user is moving. At this time, the calculation unit 11C calculates the longer one of the moving time and the net time required to execute the new job as the time required until the completion of the new job.

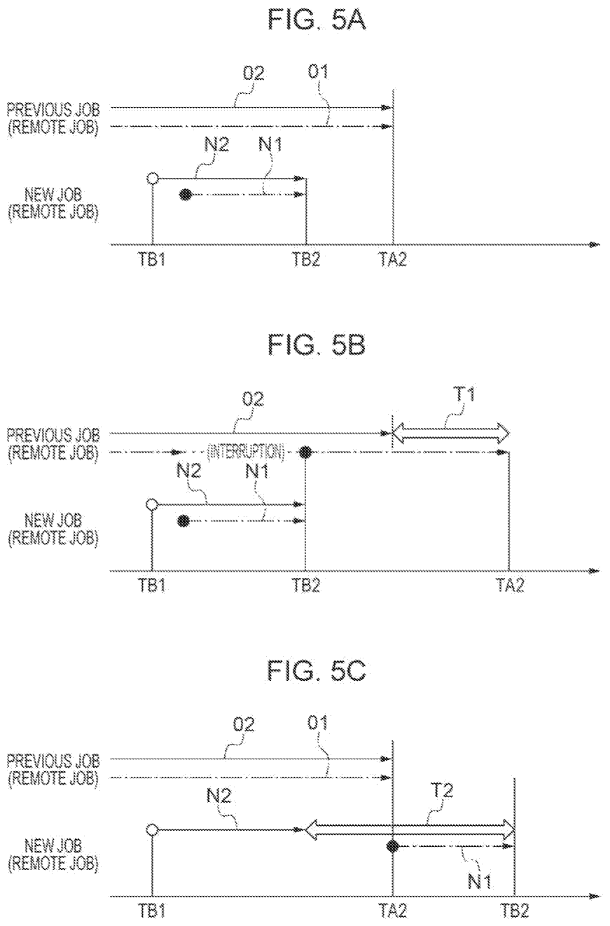

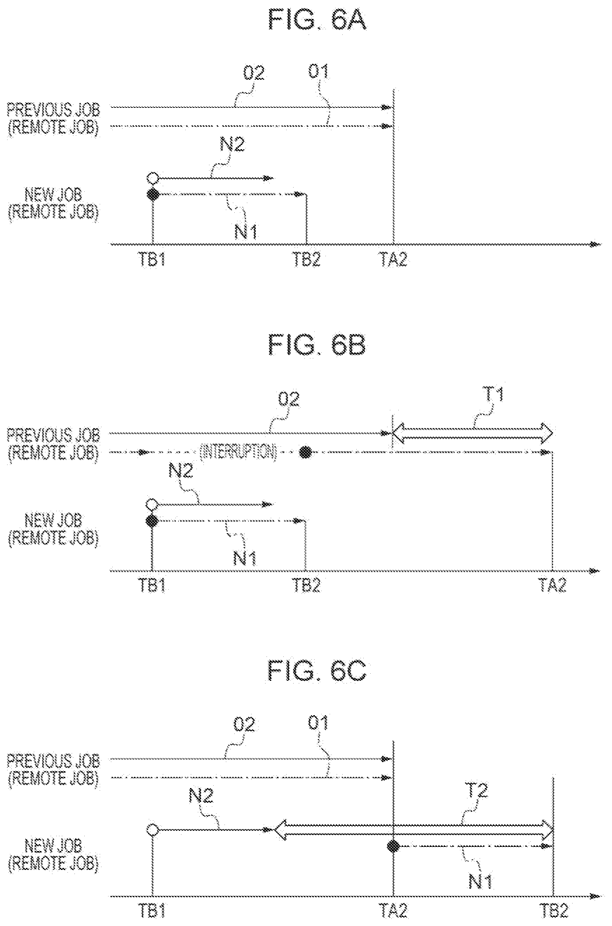

For instance, in the example illustrated in FIG. 5A, the moving time N2 is longer than the net time N1 required to execute the new job. In this case, the time required until the completion of the new job is the moving time N2. Conversely, in the example illustrated in FIG. 6A, the net time N1 required to execute the new job is longer than the moving time N2. In this case, the time required until the completion of the new job is the net time N1 required to execute the new job.

2. Time Calculation when New Job is Acquired in State where Previous Job has been Acquired

As illustrated in FIG. 3A, when the acquisition unit 11A acquires the new job in a case where the acquired “previous job” is present, the calculation unit 11C calculates the time (the time from TB1 to TA2) required from the acceptance time of the new job until the completion of the previous job.

At this time, when the acquisition unit 11A acquires the new job, the calculation unit 11C calculates the moving time 02 required from the acceptance time of the new job to the movement of the previous user (the user who has given an instruction for the previous job) to the image forming apparatus 30. A method for calculating the moving time 02 will be described below.

When the previous job is a walk-up job, the calculation unit 11C calculates the total time of the moving time and the net time required to execute the previous job as the time required until the completion of the previous job.

Conversely, when the previous job is a remote job, the calculation unit 11C calculates the longer one of the moving time and the net time required to execute the new job as the time required until the completion of the previous job.

In FIG. 3A and the like, the previous job is a remote job, and the setting portion 11E described below sets the execution timing of the previous job such that the previous job is completed at the predicted arrival time of the previous user.

### 3. Calculation of Moving Time

As described above, when the acquisition unit 11A acquires the new job, the calculation unit 11C calculates the moving time N2 required from the acceptance time of the new job to the movement of the new user to the image forming apparatus 30.

At this time, the calculation unit 11C calculates the moving time N2 of the new user from the position where the new user has given an instruction to execute the new job, the position of the image forming apparatus 30, and the gait velocity of the new user.

Specifically, as illustrated in FIG. 8, a position P1 where the new user has given an instruction to execute the new job is the position of the input device 20. The input device database 13C stores the position P1 for each of the input devices 20. The input device database 13C also stores a position P2 of the image forming apparatus 30 and a distance (travel distance) L1 between the position P1 and the position P2.

The calculation unit 11C calculates a gait velocity V of the new user. For the gait velocity V, the acquisition unit 11A acquires the time transition of the position of the new user from the mobile terminal 22 carried by the new user. The calculation unit 11C calculates the gait velocity V of the new user from the time transition.

The calculation unit 11C divides the distance L1 between the position P1 and the position P2 by the gait velocity V to calculate the moving time N2 required from the acceptance time of the new job to the movement of the new user to the image forming apparatus 30.

The calculation unit 11C may use a fixed value specified as the gait velocity V of the new user. As the fixed value, a fixed value registered for each user may be used, or the average gait velocity (e.g., 0.8 to 1.0 m/sec) of adults may be used.

As described above, when the acquisition unit 11A acquires the new job in a case where the acquired “previous job” is present, the calculation unit 11C calculates the moving time 02 required from the acceptance time of the new job to the movement of the previous user to the image forming apparatus 30.

At this time, the calculation unit 11C calculates the moving time 02 of the previous user from the position where the previous user has given an instruction to execute the previous job, the position of the image forming apparatus 30, and the gait velocity of the previous user.

The method for calculating the gait velocity of the previous user is the same as that of the new user, and detailed descriptions thereof will be omitted. The calculation unit 11C may use a specified fixed value as the gait velocity of the previous user.

### 4. Development Example

In the above description, at the acceptance time TB1 of the new job illustrated in FIG. 3A, the calculation unit 11C calculates the moving time 02 of the previous user and the time 01 required until the completion of the previous job with the acceptance time TB1 as a starting point.

However, the exemplary embodiment of the present disclosure is not limited thereto. At the acquisition time of the previous job, the calculation unit 11C calculates the moving time of the previous user and the time required until the completion of the previous job with the acceptance time of the previous job as a starting point. That is, the time TA2 at which the movement of the previous user is completed and the time TA2 at which the previous job is completed are calculated.

Therefore, the calculation unit 11C does not need to necessarily calculate the moving time 02 of the previous user and the time 01 required until the completion of the previous job at the acceptance time TB1 of the new job.

### (Comparison Unit and Setting Portion)

1. Job Setting based on Time Required until Job Completion

The comparison unit 11D compares the time 01 required from the acceptance time TB1 of the new job until the completion of the previous job with the time (the sum of the times N1 and N2) required from the acceptance time TB1 of the new job until the completion of the new job.

When the time 01 required until the completion of the previous job is equal to or shorter than the time (the sum of the times N1 and N2) required until the completion of the new job (FIG. 3A), the setting portion 11E sets the execution timing of the new job to be “after completion” of the previous job (FIG. 3B). The execution timing database 13B stores the execution timing of the new job set by the setting portion 11E (the same applies to the process described below).

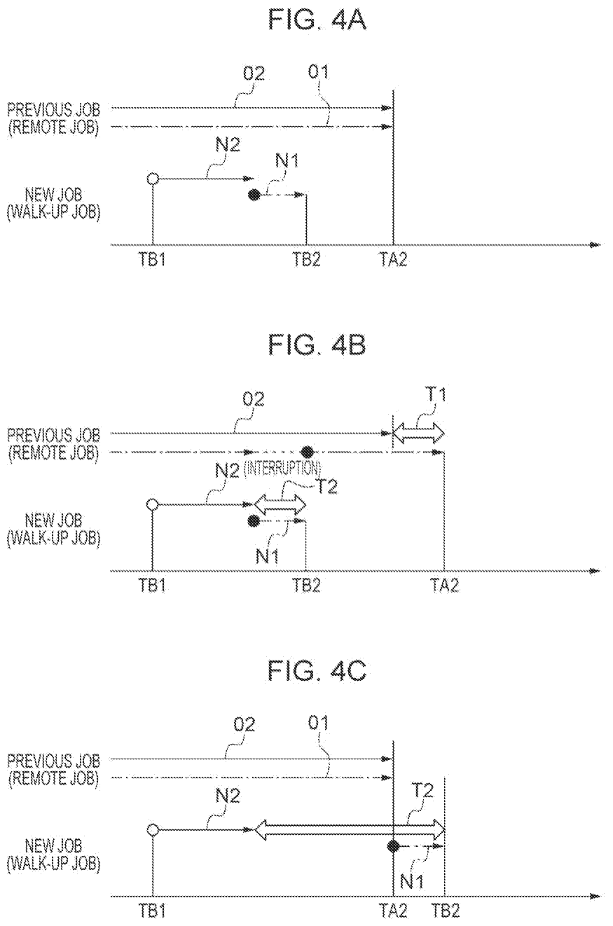

Conversely, when the time 01 required until the completion of the previous job is longer than the time (the sum of the times N1 and N2) required until the completion of the new job (FIG. 4A), the setting portion 11E sets the execution timing of the new job to be “before completion” of the previous job (FIG. 4B).

### 2. Job Setting Based on Waiting Time

The comparison unit 11D compares the waiting times in both the case (FIG. 3B) where the new job is started “after completion” of the previous job and the case (FIG. 3C) where the new job is started “before completion” of the previous job (i.e., the previous job is interrupted). Specifically, the comparison unit 11D compares the sum of a first waiting time T1 (T1=0 in FIG. 3B) from the predicted arrival time of the previous user at the image forming apparatus 30 to the completion of the previous job and a second waiting time T2 from the predicted arrival time of the new user at the image forming apparatus to the completion of the new job.

The setting portion 11E determines whether to start the new job “after completion” of the previous job or to start the new job “before completion” of the previous job so that the sum of the first waiting time T1 and the second waiting time T2 becomes small.

Specifically, the setting portion 11E sets the execution timing of the new job to be “after completion” of the previous job (FIG. 3B) when the sum of the first waiting time T1 and the second waiting time T2 is shorter than that in the case where the new job is started “before completion” of the previous job (FIG. 3C).

Conversely, the setting portion 11E sets the execution timing of the new job to be “before completion” of the previous job (FIG. 4B) when the sum of the first waiting time T1 and the second waiting time T2 is shorter than that in the case where the new job is started “after completion” of the previous job (FIG. 4C).

Priority is given to “job setting based on the waiting time” when the results of “job setting based on the time required until job completion” and “job setting based on the waiting time” described above are different.

### 3. Example of Remote Job

In the examples illustrated in FIGS. 3A and 4A, the new job is a walk-up job. Conversely, in the example illustrated in FIG. 5A, the new job is a remote job.

In this example, too, since the time 01 required until the completion of the previous job is longer than the time (the longer one of the times N1 and N2, that is, the time N2) required until the completion of the new job, the setting portion 11E sets the execution timing of the new job to be “before completion” of the previous job (FIG. 5B).

Furthermore, also in this case, the sum of the first waiting time T1 and the second waiting time T2 is shorter than that in the case where the new job is started “after completion” of the previous job (FIG. 5C), and therefore the setting portion 11E sets the execution timing of the new job to be “before completion” of the previous job (FIG. 5B).

Similarly, in the example illustrated in FIG. 6A, since the time 01 required until the completion of the previous job is longer than the time (the longer one of the times N1 and N2, that is, the time N1) required until the completion of the new job, the setting portion 11E sets the execution timing of the new job to be “before completion” of the previous job (FIG. 6B).

Also in this case, the sum of the first waiting time T1 and the second waiting time T2 is shorter than that in the case where the new job is started “after completion” of the previous job (FIG. 6C), and therefore the setting portion 11E sets the execution timing of the new job to be “before completion” of the previous job (FIG. 6B).

### 4. Timing Setting of Remote Job Completion

When the new job is a remote job, the setting portion 11E sets the execution timing of the new job such that the new job is completed (the time N1 ends) at the predicted arrival time of the new user (at the end of the time N2), as illustrated in FIG. 4B.

When the moving time N2 of the new user is longer than the net time N1 required to execute the new job, the setting portion 11E sets the execution timing of the new job such that the new job is completed at the predicted arrival time of the new user.

Conversely, when the moving time N2 of the new user is equal to or shorter than the net time N1 required to execute the new job, as illustrated in FIG. 6A, it is not necessary to perform the setting such that the new job is completed at the predicted arrival time of the new user, as illustrated in FIG. 6B.

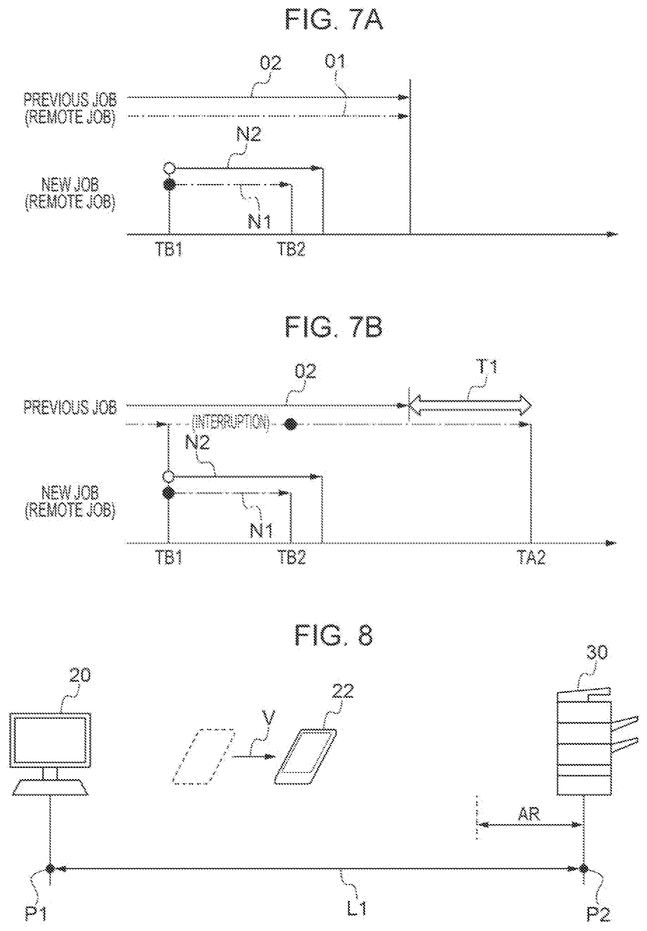

Furthermore, as illustrated in FIG. 7A, even when the moving time N2 of the new user is longer than the net time N1 required to execute the new job, it is not always necessary to set the execution timing of the new job such that the new job is completed at the predicted arrival time of the new user. For example, as illustrated in FIG. 7B, the setting may be specified such that the new job is executed immediately after the instruction is given to execute the new job.

When a remote job as the previous job is acquired, too, the setting portion 11E similarly executes timing setting for remote job completion.

### 5. Changing Execution Timing

In a case where the execution timing of the new job is set to be after the completion of the previous job, and after a specified time has elapsed, the setting portion 11E executes the new job before the completion of the previous job when the previous user is not detected and the new user is detected in the area within a specified distance from the image forming apparatus 30.

As an example, a case where the setting portion 11E sets the execution timing of the new job to be after completion of the previous job as illustrated in FIG. 3B will be described. Furthermore, in this example, the setting portion 11E sets the execution timing of the previous job such that the previous job is completed at the predicted arrival time of the previous user at the image forming apparatus 30.

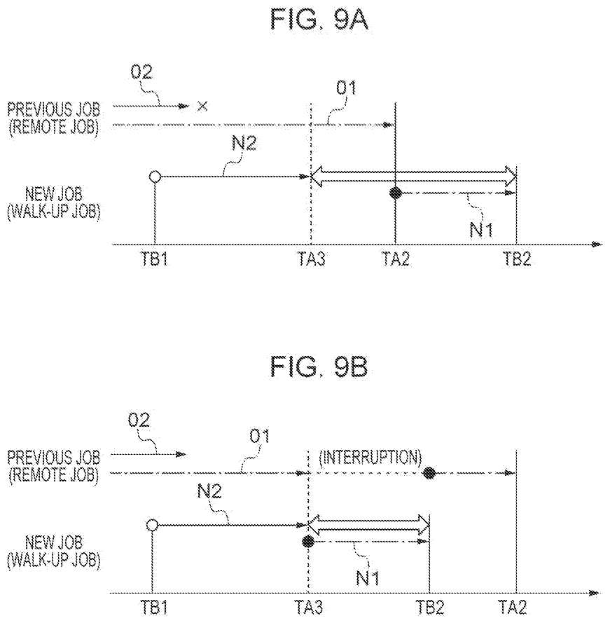

In this case, it is assumed that the previous user has reached the area AR illustrated in FIG. 8 at a time TA3 illustrated in FIG. 9A. The area AR is an area within a specified distance from the image forming apparatus 30. The time TA3 is an estimated time derived from the gait velocity of the previous user.

As illustrated in FIG. 9A, when the previous user has not reached the area AR at the time TA3 and the new user is detected in the area AR, the setting portion 11E executes the new job before the completion of the previous job, as illustrated in FIG. 9B.

### (Controller 11F)

The controller 11F executes various jobs of the image forming apparatus 30 in accordance with the job timings set by the setting portion 11E.

When the previous job and the new job are jobs involving sheet ejection and the execution timing of the new job is set to be before the completion of the previous job, the controller 11F executes a process to distinguish between the sheet for the previous job and the sheet for the new job.

The process to distinguish between sheets is, as an example, a process to change the orientation of sheets. For example, when the long-side direction of the sheet and the ejection direction coincide with each other in the previous job, the controller 11F controls the orientation of the sheet such that the long-side direction of the sheet and the ejection direction intersect with each other in the new job.

Another example of the process to distinguish between sheets is a process to change the front and back of sheets. For example, when the sheet is ejected with the printing surface turned down (facing down) in the previous job, the controller 11F ejects the sheet with the printing surface turned up (facing up) in the new job.

When there is a plurality of ejection trays, the process to distinguish between sheets also includes the control to change the ejection tray between the previous job and the new job.

Further, when the new job is a walk-up job, the controller 11F may set the image forming apparatus 30 such that the new user may start the new job at the predicted arrival time when the new user arrives at the image forming apparatus 30 and may stop other jobs being executed.

That is, for example, when the new user executes paper copy as a walk-up job, the new user inputs the instruction information such as the number of copies, color or monochrome output, and scale via the input device 20. Then, at the predicted arrival time when the new user arrives at the image forming apparatus 30, the controller 11F completes the setting of the image forming apparatus 30 based on these pieces of instruction information and stops the job being executed.

### <Posture Abnormality Detection Process>

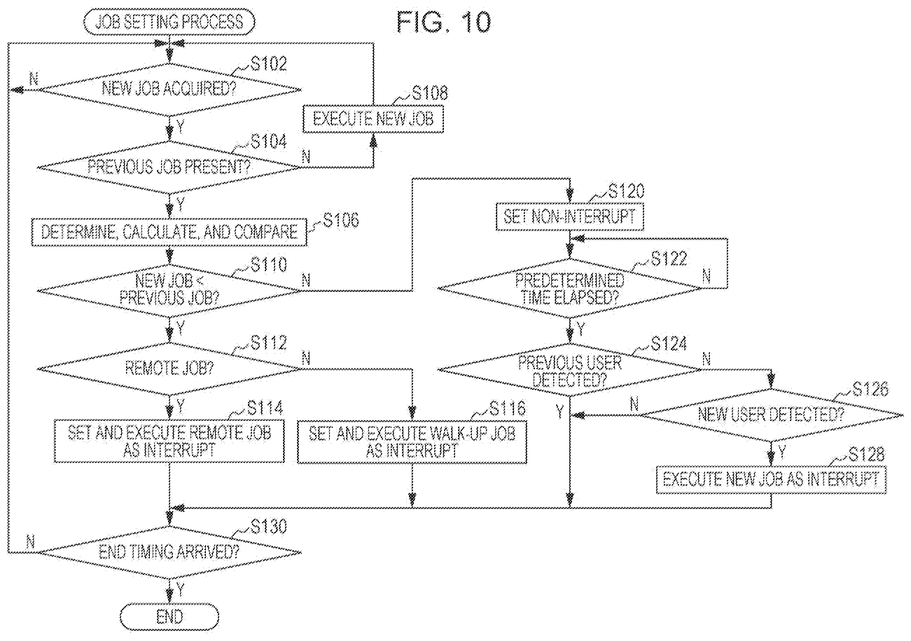

The CPU 11 of the job setting device 10 executes the job setting program 13A when accepting an instruction to execute the job setting program 13A from the user via the input unit 14, for example. Thus, as an example, the job setting process illustrated in FIG. 10 is executed. In order to avoid confusion, the description of the above-described “job setting based on the waiting time” will be omitted, and the description will be given on the assumption that “job setting based on the time required until job completion” is executed.

When the job setting process is executed, in Step S102, the CPU 11 waits to acquire a new job. When a new job is acquired, the process proceeds to Step S104.

In Step S104, the CPU 11 determines the presence or absence of an acquired previous job. When a positive determination is made in Step S104, that is, when a previous job is present, the process proceeds to Step S106. Conversely, when a negative determination is made in Step S104, that is, when no previous job is present, the process proceeds to Step S108 and the new job is executed. After Step S108, the process returns to Step S102.

In Step S106, the CPU 11 determines whether the acquired new job is a remote job or a walk-up job. Furthermore, the CPU 11 calculates and compares the time (e.g., the time 02 in FIG. 3A) required from the acceptance time of the new job until the completion of the previous job and the time (e.g., the time N1+N2 in FIG. 3A) required from the acceptance time of the new job until the completion of the new job. After Step S106, the process proceeds to Step S110.

In Step S110, the CPU 11 determines whether the time required from the acceptance time of the new job until the completion of the previous job is longer than the time required from the acceptance time of the new job until the completion of the new job. When a positive determination is made in Step S110 (for example, the case illustrated in FIG. 4A), the process proceeds to Step S112. Conversely, when a negative determination is made in Step S110, that is, when the time required from the acceptance time of the new job until the completion of the previous job is equal to or shorter than the time required from the acceptance time of the new job until the completion of the new job, the process proceeds to Step S120.

In Step S112, the CPU 11 determines whether the new job is a remote job. When a positive determination is made in Step S112, the process proceeds to Step S114. Conversely, when a negative determination is made in Step S112, the process proceeds to Step S116.

In Step S114, the CPU 11 sets the execution timing of the new job, which is a remote job, as an interrupt before the end of the previous job (e.g., FIG. 5B). At this time, the CPU 11 may set the execution timing of the new job such that the new job is completed at the predicted arrival time at which the new user arrives at the image forming apparatus 30. When the execution timing of the new job arrives, the CPU 11 causes the image forming apparatus 30 to execute the job. After Step S114, the process proceeds to Step S130.

In Step S116, the CPU 11 sets the execution timing of the new job, which is a walk-up job, as an interrupt before the end of the previous job (e.g., FIG. 4B). In this case, the CPU 11 may set the image forming apparatus 30 such that the new user may start the new job at the predicted arrival time when the new user arrives at the image forming apparatus 30. When the execution timing of the new job arrives, the CPU 11 causes the image forming apparatus 30 to execute the job. After Step S116, the process proceeds to Step S130.

In Step S114 and Step S116, when the new job is acquired before the execution timing of the new job arrives, the process returns to Step S104.

In Step S120, the CPU 11 sets the execution timing of the new job to be after the end of the previous job (non-interrupt setting, for example, FIG. 3B). After Step S120, the process proceeds to Step S122.

In Step S122, the CPU 11 waits for a specified time (an assumed time at which the previous user is assumed to have reached the area AR, which is derived from the gait velocity of the previous user) to elapse. When a positive determination is made in Step S122, that is, when the specified time has elapsed, the process proceeds to Step S124.

In Step S124, the CPU 11 determines whether the previous user has been detected in the area AR (see FIG. 8) within the specified distance from the image forming apparatus 30 when the specified time has elapsed (for example, the time TA3 in FIG. 9A). When a positive determination is made in Step S124, the process proceeds to Step S130. Conversely, when a negative determination is made in Step S124, the process proceeds to Step S126.

In Step S126, the CPU 11 determines whether the new user has been detected in the area AR (see FIG. 8) within the specified distance from the image forming apparatus 30 when the specified time has elapsed. When a positive determination is made in Step S126, the process proceeds to Step S128. Conversely, when a negative determination is made in Step S124, the process proceeds to Step S130.

In Step S128, the CPU 11 sets the execution timing of the new job as an interrupt before the end of the previous job (e.g., FIG. 9B). Further, the CPU 11 executes the new job as an interrupt. After Step S128, the process proceeds to Step S130.

In Step S130, the CPU 11 determines whether the end timing of the job setting process has arrived. The job setting process ends when an instruction to end the job setting program 13A is accepted from the user via the input unit 14, for example. When a positive determination is made in Step S130, the job setting process ends. Conversely, when a negative determination is made in Step S130, the process returns to Step S102.

### <Operation and Effect>

In the information processing system 80 according to the present disclosure, when the image forming apparatus 30 accepts the new job after accepting the previous job, as illustrated in FIG. 4A, the setting portion 11E may set the execution timing of the new job to be before the completion of the previous job in a case where the sum of the first waiting time T1 from the predicted arrival time of the previous user who has given an instruction for the previous job at the image forming apparatus 30 to the completion of the previous job and the second waiting time T2 from the predicted arrival time of the new user who has given an instruction for the new job at the image forming apparatus 30 to the completion of the new job is shorter than that in a case where the new job is started after the completion of the previous job.

Thus, the sum of the waiting times may be shorter than that in a case where the new job is started only after the completion of the previous job.

Furthermore, in the information processing system 80 according to the present disclosure, when the time 01 required until the completion of the previous job is longer than the time (N1+N2) required until the completion of the new job, as illustrated in FIG. 4A, the setting portion 11E may set the execution timing of the new job to be before the completion of the previous job, as illustrated in FIG. 4B.

Thus, the job that takes a relatively short time to be completed is executed in advance. Therefore, there is no need to wait for the completion of a job that takes a long time to be completed. Thus, it is possible to minimize the total time of the waiting time of the previous user who has given an instruction to execute the previous job and the waiting time of the new user who has given an instruction to execute the new job.

Furthermore, in the information processing system 80 according to the present disclosure, as illustrated in FIG. 5A, when the new job is a remote job, the calculation unit 11C may execute the new job while the new user is moving and calculate the longer one of the moving time and the net time required to execute the new job as the time required until the completion of the new job.

In this way, when the job does not require a direct operation of the image forming apparatus 30 for execution, the new job is executed while the new user is moving, and therefore the waiting time of the new user may be shortened as compared to a case where the new job is executed after the new user has moved to the image forming apparatus 30.

Furthermore, in the information processing system 80 according to the present disclosure, as illustrated in FIG. 5B, when the new job is a remote job, the setting portion 11E may set the execution timing of the new job such that the new job is completed at the predicted arrival time of the new user at the image forming apparatus 30.

Thus, as compared with a case where the job is completed before the new user arrives at the image forming apparatus 30 as illustrated in FIG. 7B, for example, it is possible to prevent another person from mistakenly taking the sheet.

Furthermore, in the information processing system 80 according to the present disclosure, the calculation unit 11C calculates the moving time required from the acceptance time of the new job to the movement of the previous user to the image forming apparatus.

Then, when the previous job is a walk-up job, the calculation unit 11C calculates the total time of the moving time and the net time required to execute the previous job as the time required until the completion of the previous job.

Conversely, when the previous job is a remote job, the image forming apparatus 30 executes, under the control of the controller 11F, the previous job while the previous user is moving. Furthermore, the calculation unit 11C calculates the longer one of the moving time and the net time required to execute the previous job as the time required until the completion of the previous job.

As described above, when the job does not require a direct operation of the image forming apparatus 30 for execution, the new job is executed while the previous user is moving, and therefore it is possible to shorten the waiting time of the previous user as compared with a case where the previous user executes the previous job after moving to the image forming apparatus 30.

Furthermore, in the information processing system 80 according to the present disclosure, when the previous job is a remote job, the setting portion 11E may set the execution timing of the previous job such that the previous job is completed at the predicted arrival time of the previous user at the image forming apparatus 30.

Thus, as compared with a case where the job is completed before the previous user arrives at the image forming apparatus 30, it is possible to prevent another person from mistakenly taking the sheet.

Further, in the information processing system 80 according to the present disclosure, the acquisition unit 11A may acquire the positions of the previous user and the new user. Then, as illustrated in FIG. 8, the calculation unit 11C may calculate the moving time of the previous user from the position (the position of the input device 20) at which the previous user has given an instruction to execute the previous job, the position of the image forming apparatus 30, and the gait velocity V of the previous user.

The calculation unit 11C may calculate the moving time of the new user from the position (the position of the input device 20) at which the new user has given an instruction to execute the new job, the position of the image forming apparatus 30, and the gait velocity V of the new user.

In this way, the moving time of the previous user is calculated by dividing the movement distance calculated from the position where the previous user has given an instruction to execute the previous job and the position of the image forming apparatus 30 by the gait velocity.

Similarly, the moving time of the new user is calculated by dividing the movement distance calculated from the position where the new user has given an instruction to execute the new job and the position of the image forming apparatus 30 by the gait velocity.

Furthermore, in the information processing system 80 according to the present disclosure, the calculation unit 11C may calculate the gait velocities of the previous user and the new user from the time transition of the positions of the previous user and the new user. In this way, since a different gait velocity may be calculated for each user, the calculation accuracy of the moving time is higher in comparison with a case where the fixed value specified as a gait velocity is used.

As described above, the specified fixed value may be used as the gait velocities of the previous user and the new user. In this case, since the moving time is calculated regardless of the presence or absence of movement of the user, the execution timing of the new job may be set immediately after the instruction to execute the new job is given.

Furthermore, in the information processing system 80 according to the present disclosure, as illustrated in FIG. 9A, in a case where the execution timing of the new job is set to be after the completion of the previous job, and after the specified time has elapsed, the new job is executed before the completion of the previous job when the previous user is not detected and the new user is detected in the area AR within the specified distance from the image forming apparatus 30, as illustrated in FIG. 9B.

In this way, in a case where the previous user does not come near the image forming apparatus 30 at the predicted time, the waiting time of the new user may be shortened.

Furthermore, in the information processing system 80 according to the present disclosure, the direct operation of the image forming apparatus in the walk-up job includes an authentication operation of the new user. That is, in the information processing system 80, even when the authentication of the new user is required, the total time of the waiting time of the previous user and the waiting time of the new user may be shortened.

Furthermore, in the information processing system 80 according to the present disclosure, when the previous job and the new job are jobs involving sheet ejection, and the execution timing of the new job is set to be before the completion of the previous job, the controller 11F causes the image forming apparatus 30 to perform the process to distinguish between the sheet for the previous job and the sheet for the new job. Thus, it is possible to prevent the previous user or the new user from mistakenly taking the sheet.

Although the process in the case of acquiring only one job as a previous job has been described in the above exemplary embodiment, exemplary embodiments of the present disclosure are not limited thereto. For example, the present disclosure is also applicable to a case where a plurality of jobs is acquired as illustrated in FIG. 4B. Thus, the waiting time of three or more users may be shortened.

Furthermore, in the above-described exemplary embodiment, when the specified time has elapsed after an instruction to execute the new job is given (e.g., the time TA3 in FIG. 9A), it is determined whether the previous user has been detected in the area AR (see FIG. 8) within the specified distance from the image forming apparatus 30, and the execution timing of the new job is set as an interrupt before the end of the previous job (Steps S122 to S128), but exemplary embodiments of the present disclosure are not limited thereto. Such a process of detecting the previous user may not necessarily be executed.

In the above-described exemplary embodiment, for example, as a hardware structure of a processing unit that executes each process of the acquisition unit 11A, the job determination unit 11B, the calculation unit 11C, the comparison unit 11D, the setting portion 11E, and the controller 11F, various processors described below may be used. As described above, the various processors include a CPU which is a general-purpose processor that functions as a processing unit by executing software (program), a programmable logic device (PLD) which is a processor whose circuit configuration may be changed after manufacturing, such as a field-programmable gate array (FPGA), a dedicated electric circuit which is a processor having a circuit configuration designed exclusively for executing specific processing, such as an application specific integrated circuit (ASIC), and the like.

The processing unit may be configurated by one of these various processors, or may be configurated by a combination of two or more processors of the same type or different types (for example, a combination of a plurality of FPGAs or a combination of a CPU and an FPGA). Furthermore, the processing unit may be configurated by one processor.

As an example of configurating the processing unit by one processor, first, as represented by computers such as a client and a server, there is a form in which one processor is configurated by a combination of one or more CPUs and software, and the processor functions as the processing unit. Second, as represented by a system on chip (SoC) or the like, there is a form of using a processor that realizes the functions of the entire system including the processing unit by one integrated circuit (IC) chip. In this way, the processing unit is configurated using one or more of the various processors as a hardware structure.

Furthermore, more specifically, as the hardware structure of these various processors, an electric circuit (circuitry) in which circuit elements such as semiconductor elements are combined may be used. As described above, the present disclosure may be implemented in various forms.

### APPENDIX

(((1)))

An information processing system comprising at least one processor configured to, when an image forming apparatus accepts a new job after accepting a job, sets execution timing of the new job to be before completion of a previous job, which is accepted previously, in a case where a sum of a first waiting time from a predicted arrival time of a previous user who has given an instruction for the previous job at the image forming apparatus to the completion of the previous job and a second waiting time from a predicted arrival time of a new user who has given an instruction for the new job at the image forming apparatus to completion of the new job is shorter than the sum in a case where the new job is started after the completion of the previous job.

(((2)))

The information processing system according to (((1))), wherein the processor is configured to:
compare a time required from an acceptance time of the new job until the completion of the previous job and a time required from an acceptance time of the new job until the completion of the new job,
when the time required until the completion of the previous job is equal to or shorter than the time required until the completion of the new job, set the execution timing to be after the completion of the previous job; and
when the time required until the completion of the previous job is longer than the time required until the completion of the new job, set the execution timing to be before the completion of the previous job.
   (((3)))

The information processing system according to (((1))) or (((2))), wherein the processor is configured to:
calculate a moving time required from the acceptance time of the new job to movement of the new user to the image forming apparatus;
when the new job is a job that requires a direct operation of the image forming apparatus for execution, calculate a total time of the moving time and a net time required to execute the new job as a time required until the completion of the new job; and
when the new job is a job that does not require a direct operation of the image forming apparatus for execution, execute the new job while the new user is moving and calculates a longer one of the moving time and the net time required to execute the new job as the time required until the completion of the new job.
   (((4)))

The information processing system according to (((3))), wherein when the new job is a job that does not require a direct operation of the image forming apparatus for execution, the execution timing of the new job is set such that the new job is completed at the predicted arrival time of the new user.

(((5)))

The information processing system according to (((3))) or (((4))), wherein the processor is configured to:
calculate a moving time required from the acceptance time of the new job to movement of the previous user to the image forming apparatus;
when the previous job is a job that requires a direct operation of the image forming apparatus for execution, calculate a total time of the moving time and a net time required to execute the previous job as the time required until the completion of the previous job; and
when the previous job is a job that does not require a direct operation of the image forming apparatus for execution, execute the previous job while the previous user is moving and calculates a longer one of the moving time and the net time required to execute the previous job as the time required until the completion of the previous job.
   (((6)))

The information processing system according to any one of (((3))) to (((5))), wherein when the previous job is a job that does not require a direct operation of the image forming apparatus for execution, the execution timing of the previous job is set such that the previous job is completed at the predicted arrival time of the previous user.

(((7)))

The information processing system according to any one of (((3))) to (((5))), wherein the processor is configured to:
be capable of acquiring positions of the previous user and the new user;
calculate the moving time of the previous user from a position where the previous user has given an instruction to execute the previous job, a position of the image forming apparatus, and a gait velocity of the previous user; and
calculate the moving time of the new user from a position where the new user has given an instruction to execute the new job, a position of the image forming apparatus, and a gait velocity of the new user.
   (((8)))

The information processing system according to (((7))), wherein the processor is configured to calculate the gait velocity from a time transition of the positions of the previous user and the new user.

(((9)))

The information processing system according to (((7))), wherein the processor is configured to use a fixed value specified as the gait velocity.

(((10)))

The information processing system according to any one of (((2))) to (((9))), wherein the processor is configured to:
be capable of acquiring positions of the previous user and the new user; and
in a case where the execution timing of the new job is set to be after the completion of the previous job, and after a specified time has elapsed, executes the new job before the completion of the previous job when the previous user is not detected and the new user is detected in an area within a specified distance from the image forming apparatus.
   (((11)))

The information processing system according to any one of (((1))) to (((10))), wherein a plurality of jobs is included as the previous job.

(((12)))

The information processing system according to any one of (((3))) to (((9))), wherein the direct operation includes an authentication operation of the new user.

(((13)))

The information processing system according to any one of (((1))) to (((12))), wherein when the previous job and the new job are jobs involving sheet ejection and the execution timing of the new job is set to be before the completion of the previous job, the processor performs a process to distinguish between a sheet for the previous job and a sheet for the new job.

(((14)))

A program causing a system to execute a process for information processing, the process comprising, when an image forming apparatus accepts a new job after accepting a job, setting execution timing of the new job to be before completion of a previous job, which is accepted previously, in a case where a sum of a first waiting time from a predicted arrival time of a user who has given an instruction for the previous job at the image forming apparatus to the completion of the previous job and a second waiting time from a predicted arrival time of a user who has given an instruction for the new job at the image forming apparatus to completion of the new job is shorter than the sum in a case where the new job is started after the completion of the previous job.

(((15)))

An information processing method causing a system to execute a process comprising, when an image forming apparatus accepts a new job after accepting a job, setting execution timing of the new job to be before completion of a previous job, which is accepted previously, in a case where a sum of a first waiting time from a predicted arrival time of a user who has given an instruction for the previous job at the image forming apparatus to the completion of the previous job and a second waiting time from a predicted arrival time of a user who has given an instruction for the new job at the image forming apparatus to completion of the new job is shorter than the sum in a case where the new job is started after the completion of the previous job.

What is claimed is:

1. An information processing system comprising:
at least one processor configured to, when an image forming apparatus accepts a new job after accepting a job, set execution timing of the new job to be before completion of a previous job, which is accepted previously, in a case where a sum of a first waiting time from a predicted arrival time of a previous user who has given an instruction for the previous job at the image forming apparatus to the completion of the previous job and a second waiting time from a predicted arrival time of a new user who has given an instruction for the new job at the image forming apparatus to completion of the new job is shorter than the sum in a case where the new job is started after the completion of the previous job.

2. The information processing system according to claim 1, wherein the processor is configured to:
compare a time required from an acceptance time of the new job until the completion of the previous job and a time required from an acceptance time of the new job until the completion of the new job;
when the time required until the completion of the previous job is equal to or shorter than the time required until the completion of the new job, set the execution timing to be after the completion of the previous job; and
when the time required until the completion of the previous job is longer than the time required until the completion of the new job, set the execution timing to be before the completion of the previous job.

3. The information processing system according to claim 2, wherein the processor is configured to:
calculate a moving time required from the acceptance time of the new job to movement of the new user to the image forming apparatus;
when the new job is a job that requires a direct operation of the image forming apparatus for execution, calculate a total time of the moving time and a net time required to execute the new job as a time required until the completion of the new job; and
when the new job is a job that does not require a direct operation of the image forming apparatus for execution, execute the new job while the new user is moving and calculates a longer one of the moving time and the net time required to execute the new job as the time required until the completion of the new job.

4. The information processing system according to claim 3, wherein when the new job is a job that does not require a direct operation of the image forming apparatus for execution, the execution timing of the new job is set such that the new job is completed at the predicted arrival time of the new user.

5. The information processing system according to claim 3, wherein the processor is configured to:
calculate a moving time required from the acceptance time of the new job to movement of the previous user to the image forming apparatus;
when the previous job is a job that requires a direct operation of the image forming apparatus for execution, calculate a total time of the moving time and a net time required to execute the previous job as the time required until the completion of the previous job; and
when the previous job is a job that does not require a direct operation of the image forming apparatus for execution, execute the previous job while the previous user is moving and calculates a longer one of the moving time and the net time required to execute the previous job as the time required until the completion of the previous job.

6. The information processing system according to claim 5, wherein when the previous job is a job that does not require a direct operation of the image forming apparatus for execution, the execution timing of the previous job is set such that the previous job is completed at the predicted arrival time of the previous user.

7. The information processing system according to claim 5, wherein the processor is configured to:
be capable of acquiring positions of the previous user and the new user;
calculate the moving time of the previous user from a position where the previous user has given an instruction to execute the previous job, a position of the image forming apparatus, and a gait velocity of the previous user; and
calculate the moving time of the new user from a position where the new user has given an instruction to execute the new job, a position of the image forming apparatus, and a gait velocity of the new user.

8. The information processing system according to claim 7, wherein the processor is configured to calculate the gait velocity from a time transition of the positions of the previous user and the new user.

9. The information processing system according to claim 7, wherein the processor is configured to use a fixed value specified as the gait velocity.

10. The information processing system according to claim 2, wherein the processor is configured to:
be capable of acquiring positions of the previous user and the new user; and
in a case where the execution timing of the new job is set to be after the completion of the previous job, and after a specified time has elapsed,
execute the new job before the completion of the previous job when the previous user is not detected and the new user is detected in an area within a specified distance from the image forming apparatus.

11. The information processing system according to claim 1, wherein a plurality of jobs is included as the previous job.

12. The information processing system according to claim 2, wherein a plurality of jobs is included as the previous job.

13. The information processing system according to claim 3, wherein the direct operation includes an authentication operation of the new user.

14. The information processing system according to claim 1, wherein when the previous job and the new job are jobs involving sheet ejection and the execution timing of the new job is set to be before the completion of the previous job, the processor performs a process to distinguish between a sheet for the previous job and a sheet for the new job.

15. The information processing system according to claim 2, wherein when the previous job and the new job are jobs involving sheet ejection and the execution timing of the new job is set to be before the completion of the previous job, the processor performs a process to distinguish between a sheet for the previous job and a sheet for the new job.

16. A non-transitory computer readable medium storing a program causing a system to execute a process for information processing, the process comprising, when an image forming apparatus accepts a new job after accepting a job, setting execution timing of the new job to be before completion of a previous job, which is accepted previously, in a case where a sum of a first waiting time from a predicted arrival time of a user who has given an instruction for the previous job at the image forming apparatus to the completion of the previous job and a second waiting time from a predicted arrival time of a user who has given an instruction for the new job at the image forming apparatus to completion of the new job is shorter than the sum in a case where the new job is started after the completion of the previous job.

17. An information processing method causing a system to execute a process comprising, when an image forming apparatus accepts a new job after accepting a job, setting execution timing of the new job to be before completion of a previous job, which is accepted previously, in a case where a sum of a first waiting time from a predicted arrival time of a user who has given an instruction for the previous job at the image forming apparatus to the completion of the previous job and a second waiting time from a predicted arrival time of a user who has given an instruction for the new job at the image forming apparatus to completion of the new job is shorter than the sum in a case where the new job is started after the completion of the previous job.
